(19) United States
(12) Patent Application Publication
(10) Pub. No.: US 2013/0091444 A1
(43) Pub. Date: Apr. 11, 2013

(54) AUTOMATIC RENDERING OF INTERACTIVE USER INTERFACE ELEMENTS

(71) Applicants: Jonathan Peli Paul de Halleux, Seattle, WA (US); Michal J. Moskal, Seattle, WA (US); Nikolai Tillmann, Redmond, WA (US)

(72) Inventors: Jonathan Peli Paul de Halleux, Seattle, WA (US); Michal J. Moskal, Seattle, WA (US); Nikolai Tillmann, Redmond, WA (US)

(73) Assignee: MICROSOFT CORPORATION, Redmond, WA (US)

(21) Appl. No.: 13/271,221

(22) Filed: Oct. 11, 2011

(51) Int. Cl. G06F 3/00

(52) U.S. Cl. 715/762

(57) ABSTRACT

This patent relates to automatic UI rendering techniques by which specified data items can be automatically posted on a UI and rendered as interactive UI elements and/or UI sub-elements without explicit instructions for how the specified data items are to be rendered. A developer can therefore specify in a simple expression (e.g., a script) that the data item is to be posted and rendered, without having to specify how the UI elements and/or UI sub-elements are to be rendered.

In response to the expression, the data items can then be automatically posted and rendered on the UI based on the data type(s) and according to pre-defined rendering instructions. The pre-defined rendering instructions need not be specific to the data items, nor provided with the expression.

### BACKGROUND

In order to create and maintain a dynamic user interface (UI) with graphically rich interactive elements, developers typically need to have specialized training and provide explicit rendering instructions for each element they wish to render on the UI. Additionally, specialized editing software and a large display are usually necessary in order to ensure that these explicit rendering instructions are sufficient. Thus, designing UI posting and rendering activities are difficult or even impractical on devices with relatively small displays such as hand-held devices for instance. Unfortunately, while allowing for a simpler development environment, traditional text-based command line interfaces do not allow for the graphical richness or interactivity that is expected with UIs today, and thus do not provide a satisfactory solution for these developers.

### SUMMARY

Automatic user interface (UI) rendering techniques are described. By implementing these techniques, specified data items can be automatically posted on a UI and rendered as graphically rich interactive UI elements and/or UI sub-elements, without explicit instructions for how the specified data items are to be rendered. In other words, the data items can be automatically posted and rendered as UI elements and/or UI sub-elements that a user may interact with, without requiring any rendering instructions specific to the data items.

As a result, a developer wishing to post a data item as a UI element or sub-element can simply specify that the data items are to be posted and rendered. The developer, however, is not responsible for specifying how the UI element and/or UI sub-element is to be posted and rendered. In other words, the developer does not need to control how the UI element or sub-element is presented or behaves on the UI.

For example, in at least one embodiment, a developer may specify in a simple expression (e.g., a script or other type of programming instructions) that one or more data items are to be posted on a UI. For discussion purposes, the simple expression will be referred to herein as a posting script. The posting script, which may or may not be included in other script/programming instructions, can be received by the UI application implementing the UI, or other functionality (e.g., a tool or module) accessible to the UI application.

In response to the posting script, the data items can be automatically generated and the data type(s) of the generated data item(s) automatically determined. Based at least on the data type(s), the data item(s) can then be automatically posted on the UI and rendered as an interactive UI element(s) and/or UI sub-element, according to pre-defined rendering instructions.

The pre-defined rendering instructions can be accessible to the UI application but need not be specific to the data item(s), nor provided with the posting script. The developer therefore need not provide any rendering instructions in order for the data item(s) to be automatically posted and rendered. In other words, the posting script can be devoid of any instructions for how the UI element(s) and/or UI sub-element(s) are to be presented in the UI, or how they are to behave in the UI. The developer is thus relieved of the burden of having to provide explicit rendering instructions for the data item(s), and from needing specialized equipment (e.g., large display monitor) to ensure such rendering instructions are sufficient.

In at least one embodiment, the UI can be updated in response to an event, such as a user input received via a UI element and/or UI sub-element for instance. Ways in which the UI can be updated include, without limitation, a new UI element and/or UI sub-element being posted and rendered on the UI and/or an existing posted/rendered UI element and/or UI sub-element being modified or removed from the UI.

For example, a posting script might specify that a user input is to be associated with a variable (as a bound data item) such that the user input is automatically posted and rendered on the UI. In some circumstances, the predefined rendering instructions can determine whether the data item is posted and rendered as a UI element or alternatively, as a UI sub-element.

In at least one embodiment, an application wall UI can be provided. The application wall can be implemented by pre-defined rendering instructions that specify how the wall's various elements are rendered. For example, the application wall may be rendered in the context of a touch-based application on a mobile computing device. Individual data items specified to be posted on the application wall (e.g., by a posting script) during the execution of the application wall can be automatically rendered in accordance with the rendering instructions. In at least one embodiment, the data items can be arranged sequentially as UI elements on the application wall in a particular ordering scheme (e.g., from top-to-bottom or bottom-to-top).

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements.

FIG. 1 illustrates an example technique or method that may be implemented in accordance with at least one embodiment.

FIG. 2 illustrates an example UI updating technique that may be implemented in accordance with at least one embodiment.

FIGS. 3-8 illustrate an example computing environment in which the described automatic UI rendering techniques may be implemented, in accordance with at least one embodiment.

FIG. 9 illustrates an example system in which the described automatic UI rendering techniques may be implemented, in accordance with at least one embodiment.

### DETAILED DESCRIPTION

### Overview

Automatic user interface (UI) rendering techniques are described. By implementing these techniques, specified data items can be automatically posted on a UI and rendered as graphically rich interactive UI elements and/or UI sub-elements, without explicit instructions for how the specified data items are to be rendered. In other words, the data items can be automatically posted and rendered as UI elements and/or UI sub-elements that a user may interact with, without requiring any rendering instructions specific to the data items.

As a result, a developer wishing to post a data item as a UI element or sub-element can simply specify that the data items are to be posted and rendered. The developer, however, is not responsible for specifying how the UI element and/or UI sub-element is to be posted and rendered (i.e., how the UI element/sub-element is presented or behaves on the UI). In other words, the developer does not need to control how the UI element or sub-element is presented or behaves on the UI.

For example, in at least one embodiment, a developer may specify in a simple expression (e.g., a script or other type of programming instructions) that one or more data items are to be posted on a UI. For discussion purposes, the simple expression will be referred to herein as a posting script. The posting script, which may or may not be included in other script/programming instructions, can be received by the UI application implementing the UI, or other functionality (e.g., a tool or module) accessible to the UI application.

In response to the posting script, the data items can be automatically generated and the data type(s) of the generated data item(s) automatically determined. Based at least on the data type(s), the data item(s) can then be automatically posted on the UI and rendered as an interactive UI element(s), and/or as an interactive UI sub-element, according to pre-defined rendering instructions.

For ease of discussion, reference to one or more UI element(s) herein will include an interactive UI element(s) and/or an interactive UI sub-element(s), unless the UI element(s) and UI sub-element(s) are expressly described individually.

The pre-defined rendering instructions can be accessible to the UI application but need not be specific to the data item(s), nor provided with the posting script. The developer therefore need not provide any rendering instructions in order for the data item(s) to be automatically posted and rendered. In other words, the posting script can be devoid of any instructions for how the UI element(s) are to be presented in the UI, or how they are to behave in the UI. The developer is thus relieved of the burden of having to provide explicit rendering instructions for the data item(s), and from needing specialized equipment (e.g., large display monitor) to ensure such rendering instructions are sufficient.

With respect to how a UI element is presented (“looks”), the rendering instructions may cause individual UI elements to be arranged in the UI in a particular way, such as in a sequential order (e.g., from top-to-bottom, bottom-to-top, etc.) for instance.

With respect to how a UI element behaves (i.e., “feels”), the rendering instructions may determine if and how data items of a particular data type(s) affect the program state of the UI during execution. For example, a data item may be posted and rendered as a UI element configured to respond to a user input (i.e., a user interaction).

As another example, a data item of a particular data type may be posted and rendered as a UI element in a passive manner such that the program state of the UI is not interrupted. Alternatively, the data item may be posted and rendered as a UI element in a blocking manner such that the program state is interrupted (e.g., an input box may be posted and/or rendered such that the program state is interrupted and suspended until a user input is received via the input box).

As yet another example, a UI element may remain rendered on the UI in a persistent manner for as long as is practical based on the available display area, the display resolution, etc. Alternatively or additionally, UI elements may be removed from the UI based on one or more pre-defined criteria (e.g., data type, length of rendered time, etc.).

In at least one embodiment, the UI can be updated in response to an event, such as a user input received via an interactive UI element for instance. Ways in which the UI can be updated include, without limitation, a new UI element and/or UI sub-element being posted and rendered on the UI, and/or an existing posted/rendered UI element being modified or removed from the UI.

For example, a posting script might specify that a user input is to be associated with a variable (as a bound data item) such that the user input is automatically posted and rendered on the UI. In some circumstances, the predefined rendering instructions can determine whether the data item is posted and rendered as a UI element or alternatively, as a UI sub-element.

A UI element can be modified in a variety of ways. For example, the presentation of an existing posted/rendered UI element can be changed, such as by a new UI sub-element being posted/rendered in the existing UI element or by otherwise changing the appearance or behavior of the existing UI element.

In at least one embodiment, an application wall UI can be provided. The application wall can be implemented by pre-defined rendering instructions that specify how the wall's various elements are rendered. For example, the application wall may be rendered in the context of a touch-based application on a mobile computing device. Individual data items specified to be posted on the application wall (e.g., by a posting script) during the execution of the application wall can be automatically rendered in accordance with the rendering instructions. In at least one embodiment, the data items can be arranged sequentially as UI elements on the application wall in a particular ordering scheme (e.g., from top-to-bottom or bottom-to-top).

Multiple and varied implementations are described herein. Generally, any of the features/functions described with reference to the figures can be implemented using software, hardware, firmware (e.g., fixed logic circuitry), manual processing, or any combination thereof. The terms “module”, “tool”, and/or “component” as used herein may generally represent software, hardware, firmware, or any combination thereof. For instance, the terms “tool” and “module” can represent software code and/or other types of instructions that perform specified tasks when executed on a computing device or devices.

Generally, the illustrated separation of modules, tools or components and functionality into distinct units may reflect an actual physical grouping and allocation of such software, firmware, and/or hardware. Alternatively or additionally, this illustrated separation can correspond to a conceptual allocation of different tasks to the software, firmware, and/or hardware. Furthermore, it is to be appreciated and understood that the illustrated modules, tools, and/or components and functionality described herein can be located at a single site (e.g., as implemented by a computing device), or can be distributed over multiple locations (e.g., as implemented over multiple computing devices).

### Example Technique or Method

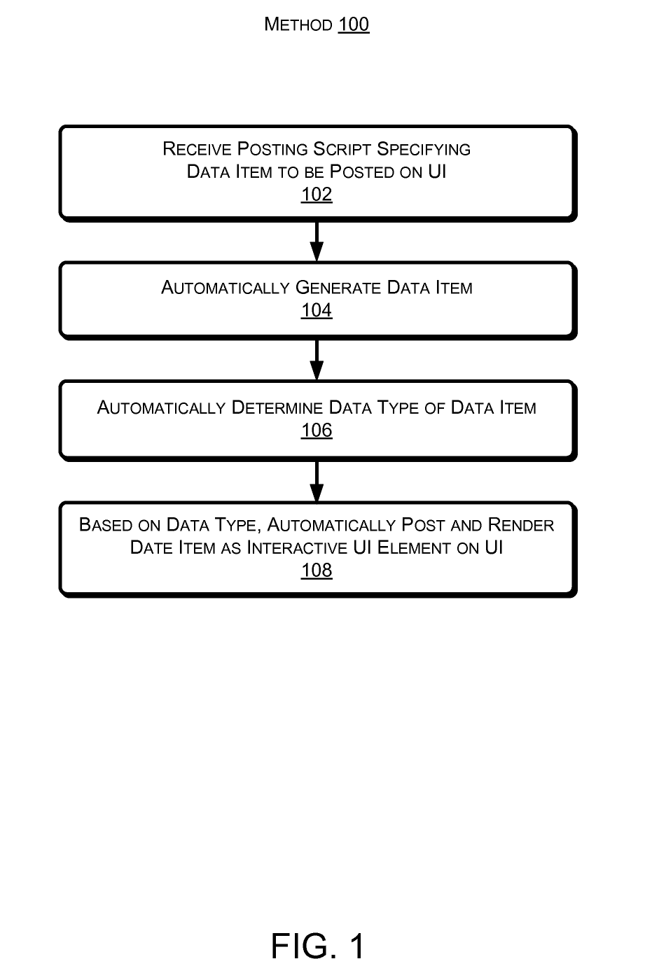

FIG. 1 illustrates a flowchart of a technique or method 100 that is consistent with at least one implementation of the described automatic UI rendering techniques.

At block 102, a posting script can be received that specifies a data item to be posted on a UI, such as an application wall for instance. This can be accomplished in any suitable way. For example, a developer may enter the posting script in an editor or other application that allows the posting script to be executed or otherwise processed by an interpreter, compiler, or other functionality.

At block 104, the data item specified in the posting script can be automatically generated (e.g., searched for and retrieved). This can be accomplished in any suitable way during the UI application's runtime in response to receiving the posting script. For example, the interpreter, compiler, or other functionality may execute or otherwise process the posting script. The posting script's instructions may call or otherwise invoke an application program interface (API) or other functionality that allows for the data item to be automatically generated and then be provided to or otherwise made available to the UI application, and thus the UI.

As a practical example of data items being generated, an executed posting script might iterate over songs stored on a device and select one or more of the songs based on some criteria, such as the release data of the song(s) (e.g., songs between 1980-1984). As another example, an executed posting script might utilize an API to query a web service to identify and retrieve one or more web pages that include one or more search terms (e.g., “cooking a potato”). As yet another example, an executed posting script might compute one or more values (e.g., the first twenty prime numbers).

At block 106, the data type of the generated data item can then be automatically determined. This can be accomplished in any suitable way during the UI application's runtime. For example, in response to receiving the data item, the UI can automatically determine the data type (e.g., text string, number, song, image, etc.) by examining metadata and/or other information about the data item.

At block 108, based at least in part on the determined data type, the data item can then be automatically posted on the UI and automatically rendered as an interactive UI element. This can be accomplished in any suitable way during the UI application's runtime without utilizing any information provided by the developer, and thus irrespective of any information associated with the posting script.

For example, the UI element can be automatically posted and rendered by utilizing pre-defined rendering instructions that are not specific to the data item, nor associated with (e.g., provided with) the posting script. In other words, the UI element can be automatically created for the data item and rendered without rendering instructions for the UI element being provided by or associated with the posting script.

In at least one embodiment, the pre-defined rendering instructions can cause the UI application to create and present the UI element based on the determined data type and/or by the metadata or other information associated with the data item. In this regard, the pre-defined rendering instructions can indicate whether the generated data item is to be posted and rendered as a UI element or, alternatively, as a UI sub-element.

Consider, for instance, a scenario where the data type is determined to be a song. The pre-defined rendering instructions might cause the song to be posted and rendered as a UI sub-element of a UI element for an album data item. Alternatively, the song might be posted and rendered as a UI element if the album is not rendered as an album UI element or specified in the posting script for the song data item.

Furthermore, the UI application can cause the UI element to behave (on the UI) in a manner specified in the pre-defined rendering instructions and/or by the metadata associated with the data item. For instance, in the above scenario, the pre-defined rendering instructions may cause the song UI sub-element to be rendered with a play symbol UI sub-element. The pre-defined rendering instructions may also cause the song to be played in response to a user activating the play symbol UI element.

Note that as shown in FIG. 1, blocks 102 through 108 can be performed any number of times such that multiple data items (e.g., received sequentially in a data string) can be automatically posted and rendered as UI elements on the UI based on their respective data types, and in accordance with the pre-defined rendering instructions.

For example, as described above, the pre-defined rendering instructions can cause individual UI elements to be automatically arranged on the UI in a particular order, such as sequentially from top-to-bottom, bottom-to-top, or the like. Consider an example scenario, for instance, in which UI elements are arranged sequentially from top-to-bottom on the UI based on the order in which each UI element was posted and rendered on the UI relative to the other UI element(s).

### Example UI Updating Technique

Recall from above that the UI can be automatically updated by new UI elements being posted and rendered, or by existing UI elements being modified and/or removed. For example, a posting script might specify that a data item is to be posted and rendered on the UI. As explained above, in some embodiments the predefined rendering instructions can determine whether the data item is rendered as a UI element or alternatively, as a UI sub-element.

Also recall that in at least one embodiment, the UI can be automatically updated in response to a user input. For discussion purposes, both direct and/or indirect user interactions with the UI will be referred to herein as user inputs. A direct user interaction may be the direct result of the user interacting in some way with the UI. For example, the user might select, activate, or otherwise engage a UI element, modify the UI element (e.g., rename or remove the UI element), and/or input a value via the UI element.

An indirect user interaction, in turn, may not directly result from the user interacting with the UI. For example, information such as global positioning system (GPS) or other data describing the user's location, a news feed, or the like might be sent to the UI to be posted and rendered.

In operation, the UI can be automatically updated in any suitable way during the UI application's runtime. For example, in at least one embodiment the developer may specify in one or more posting scripts that a UI element is to be associated with a programming variable associated with the UI. The developer may also specify (in the posting script(s)) how the UI is to be automatically updated in response to the variable being assigned a value. A variable can be assigned a value in a variety of ways. For example, the posting script(s) might specify that the variable be assigned a user input value entered via a UI element and/or UI sub-element.

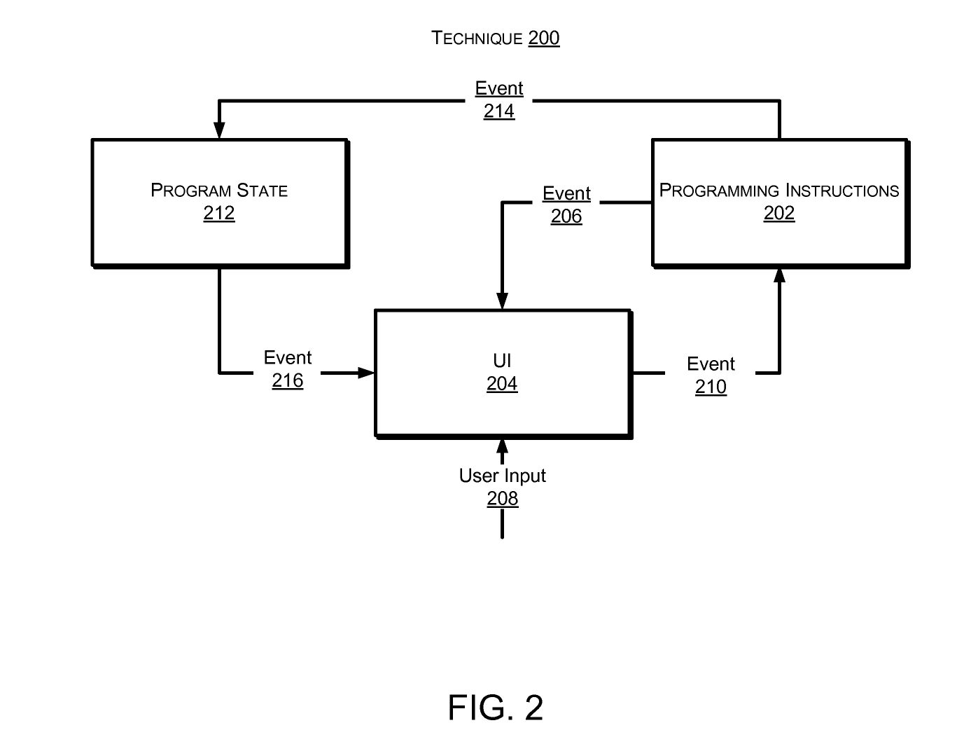

To facilitate the reader's understanding of this, FIG. 2 illustrates an example technique 200 for automatically updating a UI element. In this particular example, assume that the developer has included two posting scripts in programming instructions (e.g., script) 202 associated with a UI 204. The first posting script specifies that a request for a number is to be posted on the UI 204 and rendered as an interactive input box UI element. The first posting script also associates the input box UI element with a programming variable such that a value entered into the input box UI element (as a user input) is bound to that variable. An example of such a posting script (in pseudo code) might be the sample posting script: “x :=UI -> ask_number ( )”.

The second posting script, in turn, specifies that when a value is entered into the input box UI element, a new UI element with the entered value is posted and rendered on the UI 204. An example of such a posting script (in pseudo code) might be the sample posting script: “x -> post_to_UI ( )”.

Assume that in this example, programming instructions 202 carry out the instructions of the first posting script (e.g., calls or otherwise invokes an API). As a result, the interactive input box UI element is posted/rendered on the UI 204, as shown by event 206. In addition, the interactive UI element is also associated with the variable in the programming instructions 202.

Now assume that the user interacts with the UI 204 by entering a value, shown in FIG. 2 as user input 208, into the input box UI element. Note that here, the user input is thus a value resulting from a direct user interaction by the user with the UI. However, it is to be appreciated and understood that this is but one example, and the discussion regarding FIG. 2 is equally applicable to other types of direct and indirect user interactions with the UI.

As a result of the user input 208 being received, and in accordance with the instructions of the posting scripts, the user input 208 is bound to the variable, as shown by event 210. In the context of the sample posting scripts above, the value becomes bound to the variable “x”. The programming instructions 202, in turn, then modify the UI's program state 212 to reflect the user input 208 being bound as the variable, as shown by event 214.

Finally, the modification of the program state 212 then automatically triggers an update to the UI 204 in accordance with pre-defined rendering instructions, as shown by event 216. This might include the input box UI being updated so that the entered value is shown in the input box. Alternatively or additionally, this might include the entered value being posted to the UI and rendered as a new UI element.

### Example Computing Environment

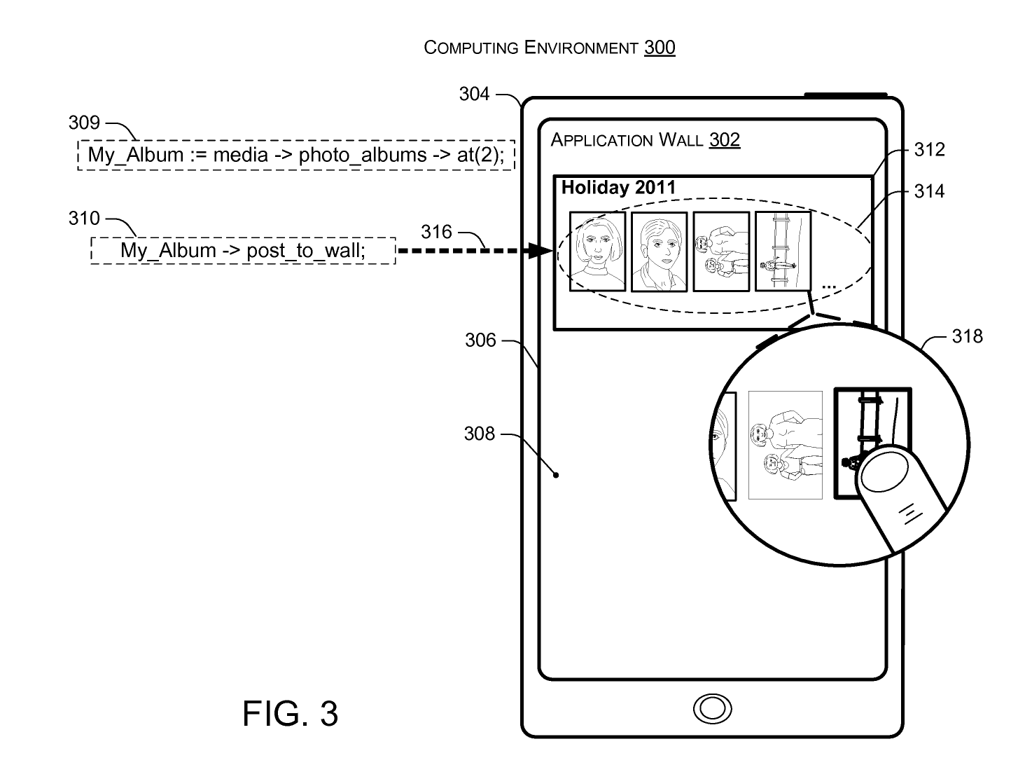

To facilitate the reader's understanding of the described automatic UI rendering techniques, FIG. 3 illustrates an example computing environment 300 in which the described automatic UI rendering techniques may be implemented. For discussion purposes, the computing environment 300 is described here in the context of a UI embodied as an application wall 302. Application wall 302, in turn, is described here in the context of being implemented on a hand-held computing device 304 with a touch-screen configured to receive user inputs, such as a phone, smart phone, tablet-type computer, or the like. However, it is to be appreciated and understood that this is but one example, and these techniques are applicable to any kind of computing device.

In this example, application wall 302 includes various interactive UI elements, including a UI border 306 that surrounds a UI display region 308 in which posted data items may be automatically rendered as interactive UI elements. For discussion purposes, assume that in this example a developer has specified that a second photo album data item in a directory of photo albums on the hand-held computing device 304 is to be generated and posted on the application wall 302. In this scenario, the second photo album might be entitled “Holiday 2011”. In accordance with the techniques described herein, this has been accomplished simply by the developer specifying in a posting script 309 that the second photo (“Holiday 2011”) is to be bound to the variable My_Album, and in a posting script 310 that My Album is to be posted and rendered on the application wall 302.

Note that a data item may be manifest as any of a wide variety of different types of data. Furthermore, a data item may include, or otherwise be associated with, any number of other data items or data types which may be considered sub-data items of the data item. For example, the photo album “Holiday 2011” may be generated and posted on the application wall 302. Furthermore, “Holiday 2011” may include a collection of various images that may be considered sub-data items of “Holiday 2011”.

Continuing, as specified in the posting script 310, here “Holiday 2011” has been automatically posted (i.e., added) to application wall 302 and rendered as an interactive UI element 312 in the UI display region 308. Furthermore, in accordance with pre-defined rendering instructions for the application wall 302, at least some of the individual images that make up the “Holiday 2011” have also been rendered as interactive UI sub-elements 314.

As illustrated and described above in the context of the technique or method 100 of FIG. 1, once a posting script is received (e.g., via an interpreter, complier, or other functionality), the data item(s) specified in the posting script can be automatically generated (e.g., located and retrieved). The data type(s) of the data item(s) can then be determined and used in accordance with the pre-defined rendering instructions to post and render the data item(s). Accordingly, for ease of illustration, this technique or method is represented by the black dotted arrow 316.

In this example, note that additional instructions other than the posting script 310 have not been provided by the developer, nor are such additional instructions necessary for “Holiday 2011” to be rendered as the interactive UI element 312. Instead, the interactive UI element 312 and interactive UI sub-elements 314 have been automatically created and presented on the application wall 302 in accordance with the pre-defined rendering instructions. Note that these pre-defined rendering instructions are not provided with the posting script 310, nor are they specific to “Holiday 2011”, or the various images of “Holiday 2011”.

As explained above, these pre-defined rendering instructions can specify how data items of a particular data type are to be presented on the application wall 302 and how they will behave. For example, the pre-defined rendering instructions here can specify that UI elements will be incrementally arranged on application wall 302 in a sequential order from top-to-bottom. As a result, the UI element 312 has been automatically presented here in the top portion of the UI display region 308.

Additionally, the rendering instructions here can specify how the UI element 312, and the UI sub-elements 314, will respond to interaction by a user (i.e., a user input). An example of a user input is shown in callout 318, where the user is selecting one of the UI sub-elements 314 for enhanced viewing, editing (e.g., renaming), rearranging/repositioning, or the like.

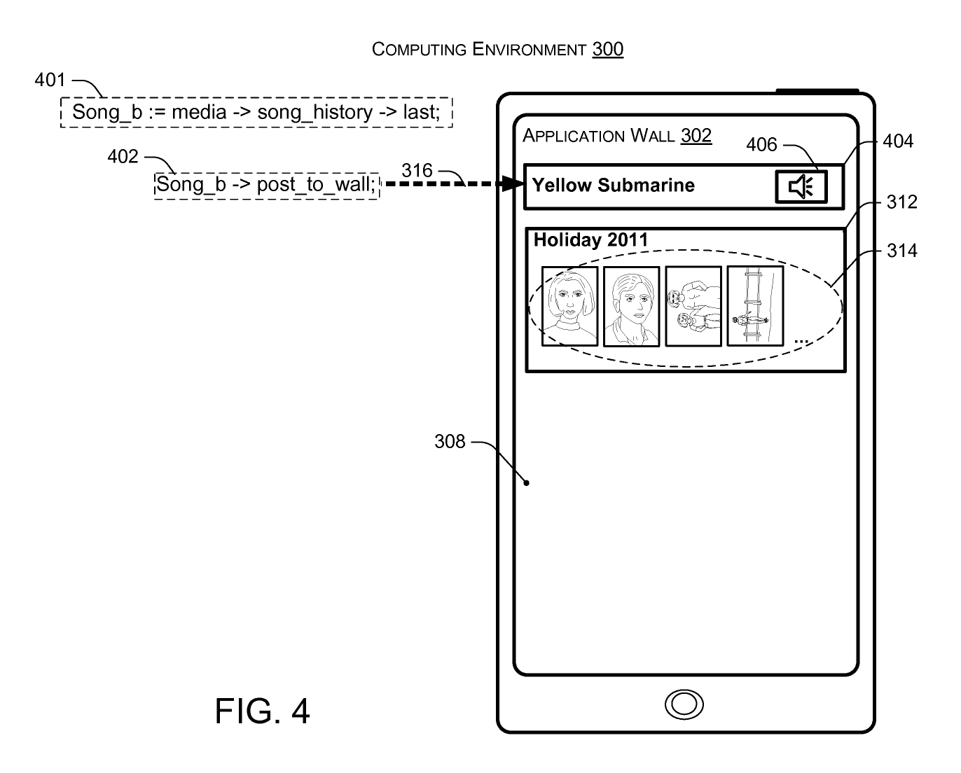

For discussion purposes now assume that, as illustrated in FIG. 4, the developer specifies in a posting script 401 that the last song played on the hand-held computing device 304 is to be bound to the variable Song_b. In this scenario, the last song played might be entitled “Yellow Submarine”. Also assume that the developer has specified in a posting script 402 that song_b (“Yellow Submarine”) is to be posted and rendered on the application wall 302.

As a result, note that “Yellow Submarine” has been automatically posted and rendered as a new interactive UI element 404. Also note that interactive UI element 404 is presented here in the top portion of the UI display region 308. Furthermore, in accordance with the pre-defined rendering instructions, a play control for playing “Yellow Submarine” has been also rendered as an interactive UI sub-element 406.

While not shown here, the user may interact with UI element 404 in accordance with the pre-defined rendering instructions. For example, the user might be able to select and rename the title “Yellow Submarine”, select the UI sub-element 406 to play “Yellow Submarine”, etc. Note that as with the UI element 312, rendering instructions have not been provided by the developer, nor are they necessary, for “Yellow Submarine” to be rendered as the UI element 312.

Assume that in this example, the pre-defined rendering instructions specify that individual UI elements posted and rendered on the application wall 302 are to remain presented in the UI display region 308 in a persistent manner. Therefore, note that here, the UI element 404 and the UI element 312 both remain rendered since there is available display area in the UI display region 308.

However, also note that the UI elements 312 and 404 have been automatically arranged in a sequential order from top-to-bottom based on the order in which each was posted and rendered. Since the UI element 312 was posted and rendered prior to the UI element 404, the UI element 312 is presented below the UI element 404.

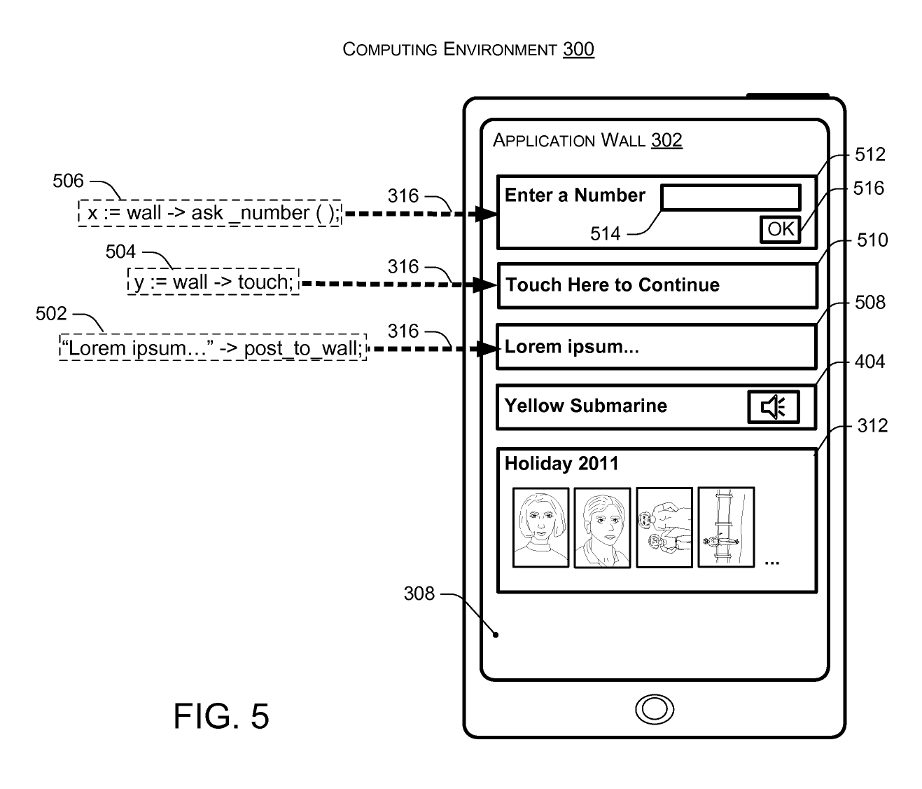

To further illustrate additional types of data items that may be automatically posted and rendered as interactive UI elements, now assume that, as illustrated in FIG. 5, the developer has specified in multiple posting scripts 502, 504, and 506 that other respective data items are to be posted and rendered on the application wall 302. As a result, multiple new interactive UI elements 508, 510, and 512 are now presented in the UI display region 308 in a sequential order from top-to-bottom based on the order in which each was posted and rendered.

More particularly, here the posting script 502 specifies that a text string data item “Lorem ipsum . . . ” is to posted and rendered on application wall 302. Accordingly, the text “Lorem ipsum . . . ” has been automatically posted and rendered as the UI element 508 in the UI display region 308. Note that in accordance with the pre-defined rendering instructions, the UI element 508 is presented above the UI element 404, which was posted and rendered prior to the UI element 508.

Continuing, here the posting script 504 specifies that a tactile input data item is to be posted and rendered on the application wall 302. A tactile input box labeled “Touch Here to Continue” has thus been automatically posted and rendered as the UI element 510 in the UI display region 308. Note that in accordance with the pre-defined rendering instructions, the UI element 510 is presented above the UI element 508, which was posted and rendered prior to the UI element 510.

Recall from above that in some circumstances, a developer may want the UI to be automatically updated in response to a user input. For example, the developer might want a new UI element to be automatically posted/rendered in response to the user input. In the example relative to FIG. 2, to accomplish this the developer provided a posting script that specified that a request for input (e.g., a number) was to be posted/rendered as a UI element, and that the UI was to be associated with a variable. The developer also provided another posting script that specified that a new UI element with the entered input was to be posted and rendered

Similarly, for discussion purposes, assume here that the developer wants a new interactive UI element with an entered input to be automatically posted/rendered. The developer has thus provided the posting script 506 which specifies that a request for a number is to be posted on the application wall 302 and rendered as a UI element. The posting script 506 also associates the UI element with a variable “x”.

Accordingly, as specified by the posting script 506, an input box has been automatically posted and rendered as the UI element 512. Furthermore, in accordance with the pre-defined rendering instructions, a value box for displaying an entered value and a confirmation button labeled “OK” have also been posted and rendered as interactive UI sub-elements 514 and 516, respectively. Note that in accordance the pre-defined rendering instructions, the UI element 512 is presented above the UI element 510, which was posted and rendered prior to the UI element 512.

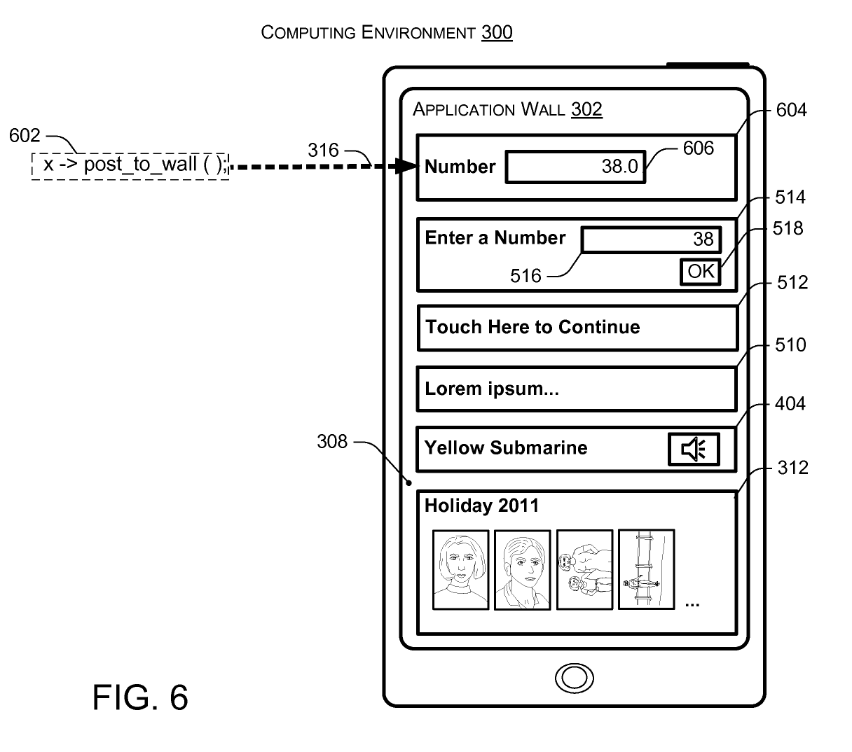

Now assume that, as illustrated in FIG. 6, a user interacts with the UI element 514 by inputting the number value “38” into the UI sub-element 516 and then confirming and submitting this value by activating the UI sub-element 518. Also assume that in response to the value being submitted, the instructions of a posting script 602 are performed. Note that the posting script 602 specifies that a new UI element with the entered number value bound to the variable “x” is to be posted and rendered on the application wall 302.

Accordingly, as specified by the posting script 602, a new interactive UI element 604 labeled “Number” has been automatically posted and rendered in accordance with the pre-defined rendering instructions. Furthermore, a display box showing the entered number value “38.0” has also been posted and rendered as an interactive UI sub-element 606 of the UI element 604. Thus, for the number value (e.g., “38.0”) bound to the variable “x”, the pre-defined rendering instructions corresponding specify that a new UI element having the rendering characteristics of UI element 604 is to be posted and rendered on the application wall 302.

Note that in accordance the pre-defined rendering instructions, the UI element 604 is presented above the UI element 514, which was posted and rendered prior to the UI element 604.

Recall that in addition to automatically posting and rendering a new UI element (e.g., UI element 520), a UI can also be automatically updated in other ways as well. For example, as noted above, the presentation and/or behavior of a UI element already posted and rendered may be automatically modified.

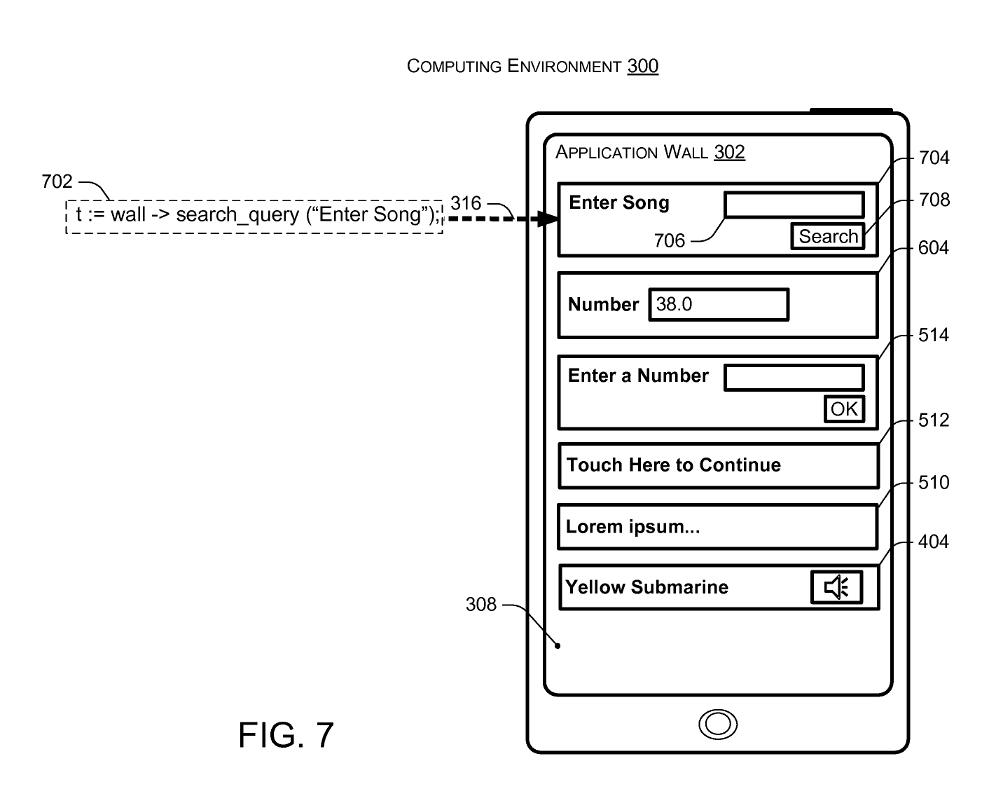

Accordingly, as illustrated in FIG. 7, now assume that the developer specifies in a posting script 702 that that a request for a text string is to be posted on the application wall 302 and rendered as a UI element. Note that the posting script also associates the UI element with a variable “t”.

As specified by the posting script 702, here an input box labeled “Enter Song” has thus been automatically posted and rendered as an interactive UI element 704 in the UI display region 308. Furthermore, in accordance with the pre-defined rendering instructions, a text box for displaying entered text and a search button labeled “Search” have also been posted and rendered as interactive UI sub-elements 706 and 708, respectively.

Note that in accordance the pre-defined rendering instructions, the UI element 704 is presented above the UI element 604, which was posted prior to the UI element 704. Furthermore, given the available display area in the UI display region 308, also note that the UI element 312 is no longer rendered.

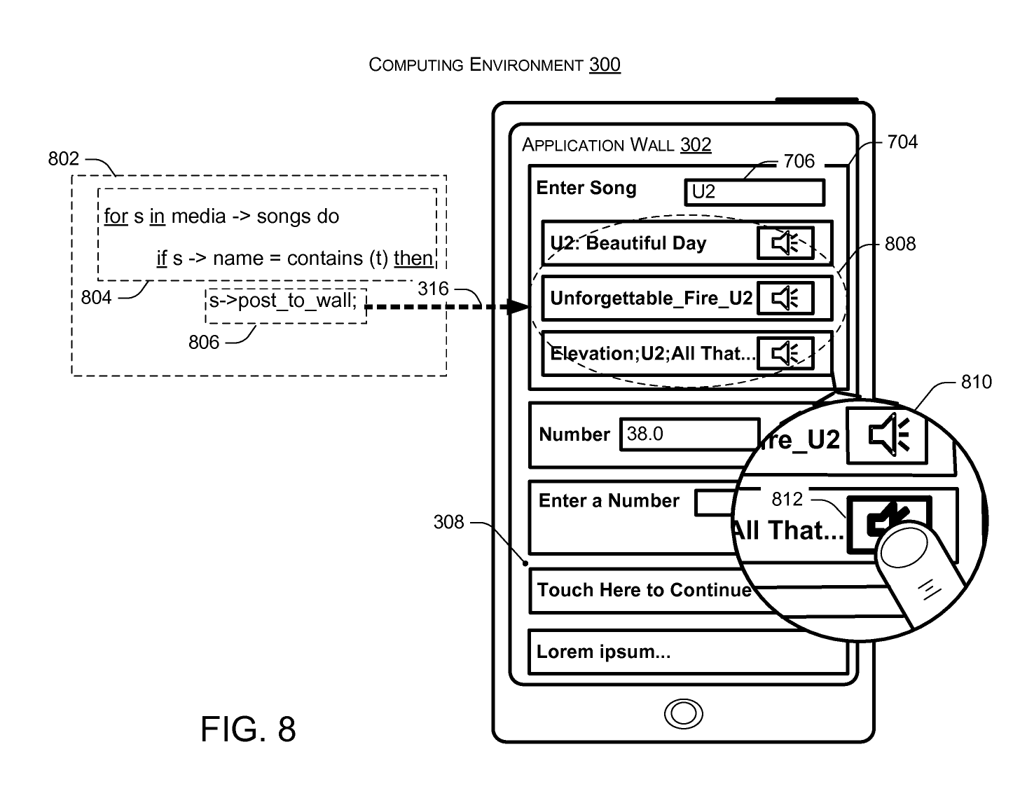

Now assume that, as illustrated in FIG. 8, the user again interacts with the application wall 302 by inputting the text value “U2” into the UI sub-element 706 and then initiating a search by activating the UI sub-element 708. Note that the developer has specified in a script 802 that that any songs with a name that includes (e.g., in their metadata) the inputted text value (here “U2”) are to be automatically generated (via technique or method 316), bound to a variable “s”, and posted and rendered on application wall 302. In this case, automatically generating may include, for instance, searching for and retrieving any songs (e.g., locally on the device 304 and/or other locations) with metadata associated with the bound text value “U2”. Further, note that to accomplish this, here script 802 includes a programmatic loop 804 and a posting script 806. (Applicant has no affiliation with the band U2 and is simply using the band and the song names to provide a real life example to the reader).

Unlike with the above-described number value data type bound to the variable “x”, assume that here the pre-defined rendering instructions do not specify that the submitted text value (here “U2”) bound to “t”, or the songs (if any) bound to “s”, are to be posted and rendered as one or more new UI elements on application wall 302. Instead, the pre-defined rendering instructions specify that these bound data items are to be posted and rendered on UI element 704. In other words, here the pre-defined rendering instructions specify that the UI item 704 associated with the posting script 702 is to be automatically modified to include the data items bound to “s” and “t”.

Accordingly, as specified by the posting script 802, UI element 704 has been automatically modified, and thus application wall 302 automatically updated, to include the submitted text value “U2” and three new interactive sub-UI elements 808. Note that each of the three UI sub-elements 808 is labeled with the information (e.g., artist, song title, and/or album) for each respective song.

Callout 810 illustrates another example of the interactive nature of the posted and rendered UI elements, and UI sub-elements, on the application wall 302. More particularly, in callout 810 the user is shown selecting an interactive UI sub-element 812 in order to begin playing the song identified by the label “Elevation;U2;All that . . . ”.

### Example System

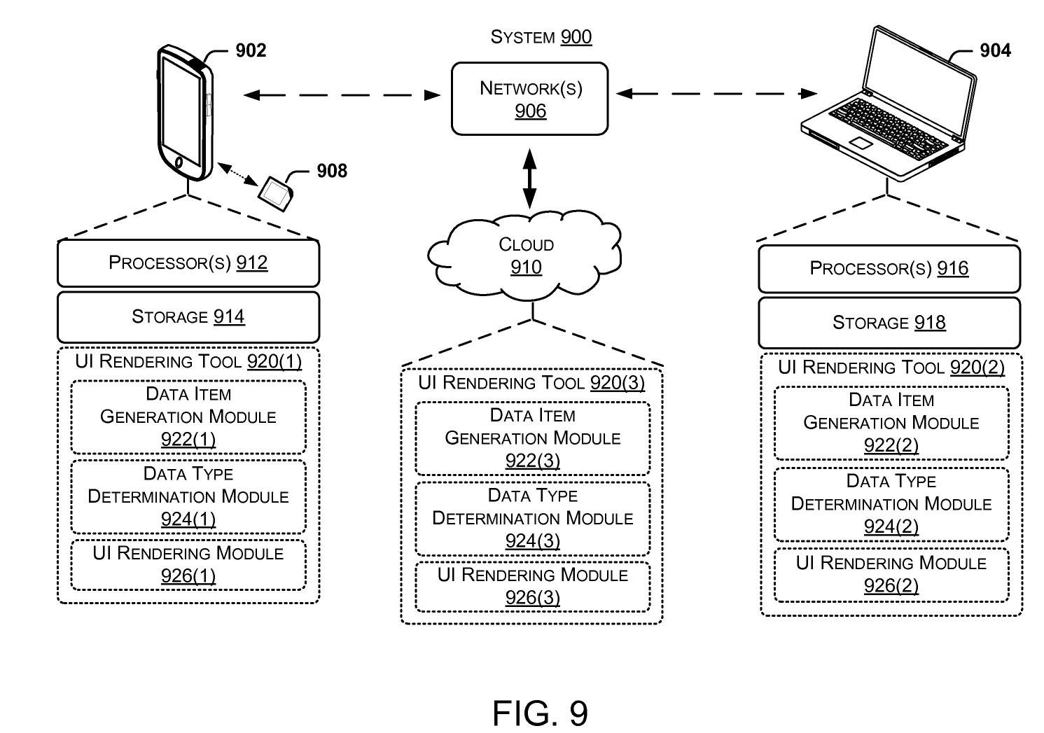

FIG. 9 illustrates an example system 900 in which the described rendering techniques may be implemented, in accordance with at least one embodiment. In this example, the system 900 includes multiple computing devices, represented here as computing devices 902 and 904. These computing devices can function in a stand-alone or cooperative manner to implement the described automatic UI rendering techniques.

Here, the computing device 902 is shown embodied as a hand-held computing device, such as computing device 302 described above for instance. Computing device 904, in turn, is shown embodied as a laptop computing device. However, this is not intended to be limiting and it is to be appreciated and understood that the example system 900 can include any number and type(s) of computing devices.

In this regard, the term “computing device”, as used herein, can mean any type of device or devices having some amount of processing capability. Examples of computing devices can include traditional computing devices, such as personal computers (desktop, portable laptop, etc.), cell phones, smart phones, personal digital assistants, or any of a myriad of ever-evolving or yet to be developed types of computing devices.

Computing devices 902 and 904 can indirectly and/or directly exchange data via one or more network(s) 906 and/or by any other suitable means, such as via an external storage 908 for instance. Examples of external storage can include optical storage devices (e.g., CDs, DVDs etc.) and flash storage devices (e.g., memory sticks or memory cards), among others.

Without limitation, the network(s) 906 can include one or more local area networks (LANs), wide area networks (WANs), the Internet, and the like. Additionally or alternatively, the computing devices 902 and/or 904 can exchange data with other resources, such as the cloud 910 for example, via the network(s) 906. As used herein, the cloud 910 refers to computing-related resources/functionalities that can be accessed via the network(s) 906, although the location of these computing resources and functionalities may not be readily apparent.

Here, computing devices 902 and 904 can each include a processor(s) (i.e., central processing unit(s)) and storage. More particularly, here the computing device 902 includes processor(s) 912 and storage 914. Similarly, the computing device 904 includes processor(s) 916 and storage 918. The processor(s) 912 and 916 can execute data in the form of computer-readable instructions to provide the functionality described herein. Data, such as computer-readable instructions, can be stored on the storage 914 and/or 918. The storage 914 and/or 918 can include one or more of volatile or non-volatile memory, hard drives, optical storage devices (e.g., CDs, DVDs etc.), or the like.

The devices 902 and 904 can also be configured to receive and/or generate data in the form of computer-readable instructions from one or more other storages, such as the external storage 908 for instance. The computing devices may also receive data in the form of computer-readable instructions over the network(s) 906 that are then stored on the computing device(s) for execution by the processor(s).

As used herein, the term “computer-readable media” can include transitory and non-transitory instructions. In contrast, the term “computer-readable storage media” excludes transitory instances. Computer-readable storage media can include “computer-readable storage devices”. Examples of computer-readable storage devices include volatile storage media, such as RAM, and non-volatile storage media, such as hard drives, optical discs, and flash memory, among others.

Recall that by utilizing the described automatic UI rendering techniques, specified data items can be automatically posted on a UI and rendered as interactive UI element(s). In accordance with these techniques, a UI element rendering tool can thus be provided that allows a user to specify that data items are to be automatically posted and rendered, without requiring that the user provide instructions for how the specified data items are to be rendered.

Accordingly, in this example the computing device 902 is shown as implementing at least part of a UI rendering tool 920 (i.e., as UI rendering tool 920(1)). At least one implementation of the UI rendering tool 920 can perform the method or technique described above relative to FIG. 1 for instance. UI rendering tool 920 can include any number of modules configured to provide the functionality described herein. Note that the modules of the UI rendering tool 920 can be made available to the UI application implementing the UI, and thus to the UI, in any suitable way. For example, in at least one embodiment, the UI application includes some or all of the UI rendering tool 920.

Here in this example, the UI rendering tool 920 is shown as including a data item generation module 922, a data type determination module 924, and a UI rendering module 926. Additionally, in some embodiments, the UI rendering tool 920 may include other modules that, for the sake of brevity, are not shown or described here.

The data item generation module 922 can be configured to receive posting scripts and automatically generate individual data items specified in individual posting scripts received by the UI rendering tool 920. For example, the data item generation module 922 can include or otherwise have access to an interpreter, compiler or other functionality to execute or otherwise process the posting script.

When executed or otherwise processed, each received posting script can invoke (e.g., call) one or more particular APIs of an API set that correspond to that particular posting script. In response, the invoked API(s) can cause functionality of the data item generation module to automatically generate the data item(s) specified in the posting script and provide the generated data item(s) to the data type determination module 924.

In operation, this can be accomplished in any suitable way. For example, in at least one embodiment, to generate a particular data item, the data item generation module 922 might search for, locate, and retrieve one or more files in a particular location or locations, such as on computing device 902 and/or 904, and/or via the cloud 910.

The data type determination module 924, in turn, can be configured to automatically determine the data type of each of the generated data items. By way of example and not limitation, a particular data item data type might be a song, image, video, map, text string, number string, tactile input, album (e.g., photo, song, or other data item collection), or the like. Recall, for instance, that examples of various data item data types were illustrated and discussed above relative to FIGS. 3-8 in the context of the application wall 302.

In operation, the data type determination module 924 can accomplish this in any suitable way. For example, in at least one embodiment, as described above, the data type determination module 924 might examine and utilize metadata and/or other information about each data item in order to identify that data item's particular data type.

Finally, the UI rendering module 926 can be configured to automatically post each of the generated data items and render them as corresponding individual interactive UI elements on the UI in accordance with pre-defined rendering instructions for the UI. This may include, for example, automatically arranging the individual interactive UI elements in a particular order, such as sequentially from top-to-bottom, bottom-to-top, or the like.

In addition to being configured to automatically post and render UI elements, in at least one embodiment the UI rendering module 926 can also be configured to automatically update the UI in other ways as well. For example, the UI rendering module 926 may change the presentation or behavior of an existing rendered UI element, and/or remove the existing rendered UI element.

In at least one embodiment, each of the UI elements is automatically rendered based on the determined data item data type of that element. In other words, for each data type, the pre-defined rendering instructions can specify how a corresponding UI element is to be presented and behave on the UI. Accordingly, the UI rendering module 926 can utilize the pre-defined instructions to determine how to render the generated data items.

As explained above, by virtue of the pre-defined rendering instructions, the developer does not need to include any instructions for how a particular data item specified in a posting script is to be presented on the UI or how it is to behave on the UI. Instead, the developer can simply specify that the particular data item is to be posted and rendered, and let the UI rendering tool automatically take care of the remaining details of how that particular data item is to be rendered.

With respect to the implementation of the UI rendering tool 920 in the system 900, in some embodiments, the computing device 902 may function in a stand-alone configuration such that all of the UI rendering tool 920 can be implemented by the computing device 902. In other words, in such embodiments the data item generation module 922, data type determination module 924, and UI rendering module 926 can all be implemented by resources provided by the computing device 902.

In other embodiments however, at least some of the UI rendering tool 920 may be implemented using other resources provided by the computing device 904, the cloud 910, and/or one or more other computing-related resources/functionalities. For example, all or part of the data item generation module 922, data type determination module 924, and/or UI rendering module 926 may be implemented by the computing device 904 and/or the cloud 910.

### CONCLUSION

Methods, devices, systems, etc., pertaining to automatic UI rendering techniques are described in language specific to structural features and/or methodological acts. However, it is to be understood that the subject matter defined in the appended claims is not necessarily limited to the specific features or acts described. Rather, the specific features and acts are disclosed as exemplary forms for implementing the claimed methods, devices, systems, etc.

1. One or more computer-readable storage media having instructions stored thereon that, when executed by a computing device, cause the computing device to perform acts, the acts comprising:
receiving a script that specifies a data item to be posted and rendered on a user interface (UI);
responsive to receiving the script, automatically generating the data item specified by the script; and
automatically posting and rendering the generated data item as an interactive UI element on the UI irrespective of the script.

2. The computer-readable storage media of claim 1, further comprising:
automatically determining a data type for the generated data item; and
automatically posting and rendering the data item as the interactive UI element based at least in part on the determined data type.

3. The computer-readable storage media of claim 1, further comprising utilizing pre-defined rendering instructions to automatically post and render the data item as the interactive UI element.

4. The computer-readable storage media of claim 3, wherein the pre-defined rendering instructions are not specific to the generated data item and are not associated with the script.

5. The computer-readable storage media of claim 1, wherein the interactive UI element comprises an interactive UI sub-element of another interactive UI element on the UI.

6. The computer-readable storage media of claim 1, further comprising automatically updating the UI based on a user input by at least one of: modifying the interactive UI element, removing the interactive UI element from the UI, or automatically posting and rendering another data item as another interactive UI element on the UI.

7. The computer-readable storage media of claim 6, wherein the user input is received via the interactive UI element.

8. The computer-readable storage media of claim 1, wherein automatically posting and rendering comprises arranging the interactive UI element sequentially on the UI based on an order in which the interactive UI element was posted and rendered on the UI relative to at least one other interactive UI element on the UI.

9. The computer-readable storage media of claim 1, wherein the computing device comprises a hand-held computing device with a touch-screen configured to receive user inputs.

10. A method comprising:
receiving one or more scripts that specify a data item to be posted and rendered on a user interface (UI); and
responsive to a user input, updating a user interface (UI) by utilizing pre-defined rendering instructions to automatically post and render the data item as an interactive UI element on the UI irrespective of the script.

11. The method of claim 10, wherein the pre-defined rendering instructions are not specific to the data item and are not associated with the one or more scripts.

12. The method of claim 10, wherein the one or more scripts further specify at least one other data item is to be automatically posted and rendered as at least one other interactive UI on the UI.

13. The method of claim 12, wherein the user input is received via the at least one other interactive UI element.

14. The method of claim 10, wherein the interactive UI element comprises an interactive UI sub-element of another interactive UI element on the UI.

15. A system comprising:
a data generation module configured to:
receive one or more scripts that specify individual data items to be posted and rendered on a user interface (UI); and
responsive to receiving the one or more scripts, automatically generate the individual data items;
a determination module configured to automatically determine individual data types of the individual data items; and
a rendering module configured to utilize pre-defined rendering instructions to automatically post and render the individual data items as individual interactive UI elements on the UI based on the individual data types and irrespective of the one or more scripts.

16. The system of claim 15, wherein at least one of the individual interactive UI elements comprises an interactive UI sub-element of at least one other of the individual interactive UI elements.

17. The system of claim 15, wherein at least one of the individual interactive UI elements is configured to receive a user input resulting from a user interaction with the UI.

18. The system of claim 17, wherein the pre-determined rendering instructions cause the rendering module to automatically post and render at least one other of the individual interactive UI elements on the UI in response to the user input being received via the at least one interactive UI element.

19. The system of claim 15, wherein the pre-defined rendering instructions are not specific to the individual generated data items and are not associated with the one or more scripts.

20. The system of claim 15, wherein the UI is implemented on a hand-held computing device with a touch-screen configured to receive user inputs.
